(19) United States
(12) Patent Application Publication
(10) Pub. No.: US 2011/0124232 A1
(43) Pub. Date: May 26, 2011

(54) POWER ADAPTER CONNECTOR

(75) Inventor: AN-PANG CHEN, Tu-Cheng (TW)

(73) Assignee: HON HAI PRECISION INDUSTRY CO., LTD., Tu-Cheng (TW)

(21) Appl. No.: 12/699,837

(22) Filed: Feb. 3, 2010

(30) Foreign Application Priority Data
Nov. 23, 2009 (CN) 200910310237.9

(51) Int. Cl. H01R 27/02

(52) U.S. Cl. 439/638

(57) ABSTRACT

A power adapter connector includes a main body, wherein a first side of the main body mounts a first interface, a second side of the body mounts a second interface different from the first interface and a power interface. The first interface is electrically connected to the second interface. The second interface and the power interface are capable to be connected to an interface and a power input interface of a first electronic device at one time, so as to allow a second electronic device, whose interface suits for the first interface, to connect to the first electronic device. The second interface and the power interface are closely mounted, therefore it is allowed to mount the interface and power input interface of the first electronic device closely to save space on the first electronic device.

### BACKGROUND

1. Technical Field

The present disclosure relates connectors, and more particularly to a power adapter connector.

2. Description of Related Art

Small portable devices, such as mini netbooks, tablets, personal digital assistants (PDAs), mobile internet devices (MIDs), and so on, are convenient due to their portability. However, because they are small, there is little space to mount enough peripheral connectors for users.

### BRIEF DESCRIPTION OF THE DRAWINGS

FIG. 1 is a front elevational plan view of an exemplary embodiment of a power adapter connector.

FIG. 2 is a right elevational plan view of the power adapter connector of FIG. 1.

FIG. 3 is a rear elevational plan view of the power adapter connector of FIG. 1.

FIG. 4 is a circuit diagram of the power adapter connector of FIG. 1.

FIG. 5 is a front elevational plan view of another exemplary embodiment of a power adapter connector.

FIG. 6 is a right elevational plan view of the power adapter connector of FIG. 5.

FIG. 7 is a rear elevational plan view of the power adapter connector of FIG. 5.

### DETAILED DESCRIPTION

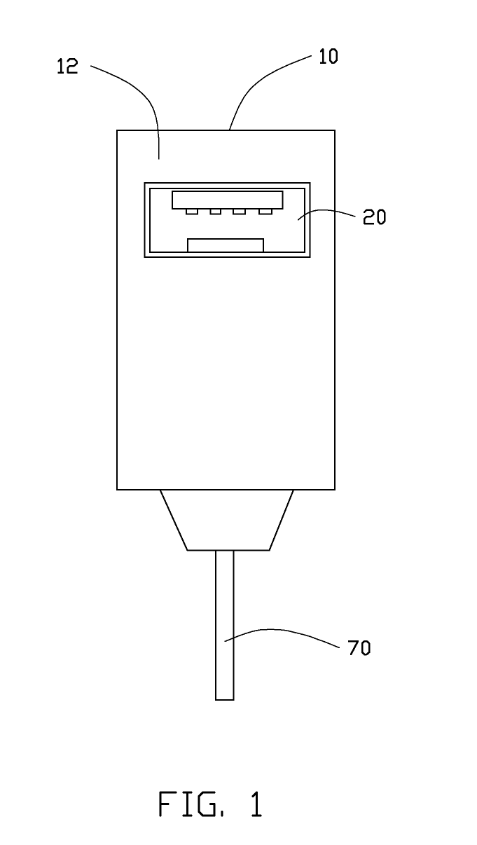

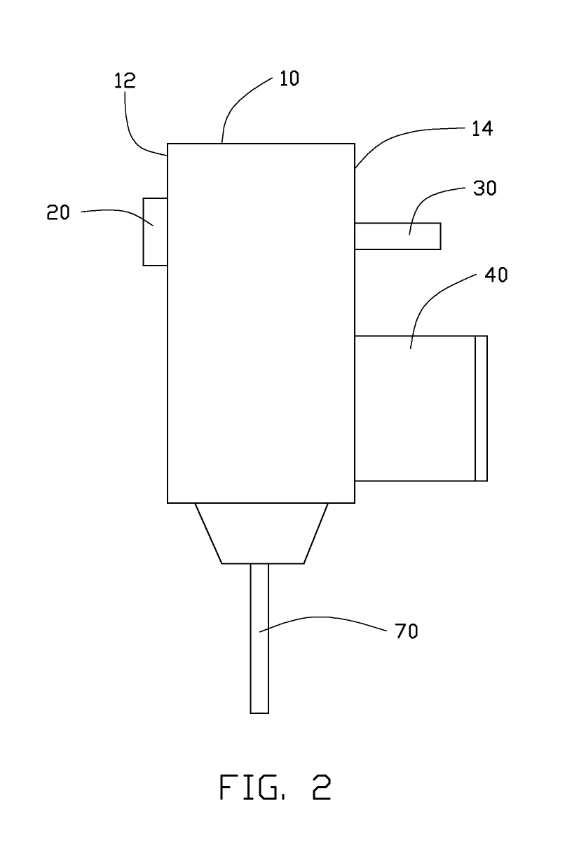

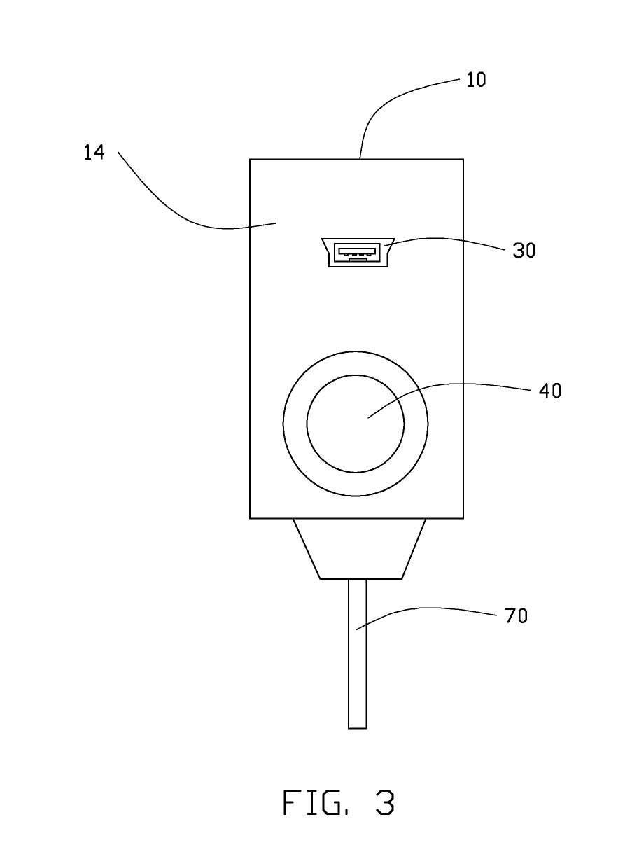

Referring to FIGS. 1 to 3, an embodiment of a power adapter connector includes a main body 10, a first universal serial bus (USB) interface 20 mounted to a first side 12 of the main body 10, and a second USB interface 30 and a power interface 40 both mounted to a second side 14 of the main body 10 opposite to the first side 12. The second USB interface 30 is above the power interface 40.

The first USB interface 20 is connected to the second USB interface 30, and is able to communicate with a USB interface of a portable electronic device, such as a mini netbook, through the second USB interface 30. The second USB interface 30 is a mini USB interface smaller than the USB interface 20 and able to fit a mini USB interface of the mini netbook.

The power interface 40 is connected to a power adapter through a wire 70, in order to transmit power to the netbook.

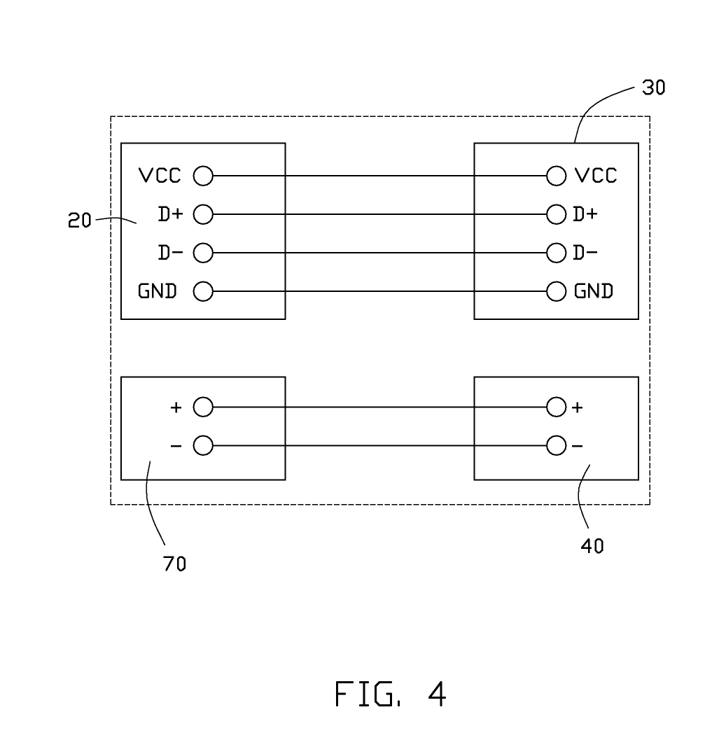

Referring to FIG. 4, a power pin VCC, a ground pin GND, and two signal pins D+ and D− of the first USB interface 20 are electrically connected to a power pin VCC, a ground pin GND, and two signal pins D+ and D− of the second USB interface 30, respectively. A positive contact and a negative contact of the power interface 40 are correspondingly connected to a positive and a negative lead of the wire 70.

In use, the power interface 40 and the second USB interface 30 are respectively connected to a power input interface and a mini USB interface of the mini netbook. Therefore, the mini netbook may receive power from the power adapter through the wire 70 and the power interface 40. A USB interface of a peripheral device may plug into the first USB interface 20, so as to connect the peripheral device to the netbook.

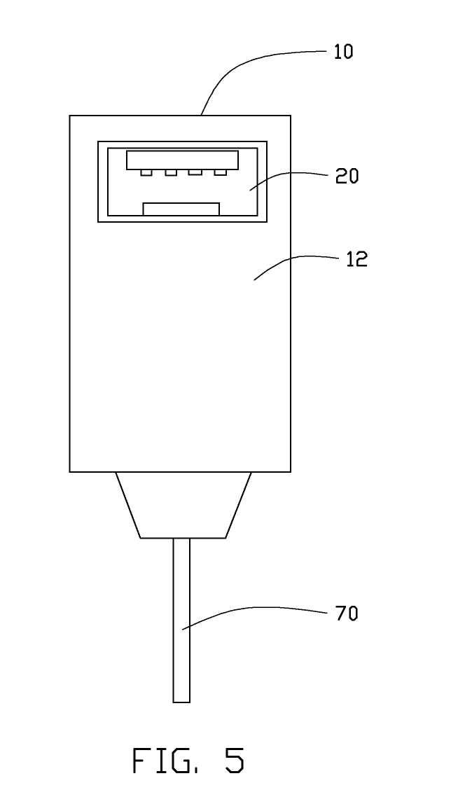

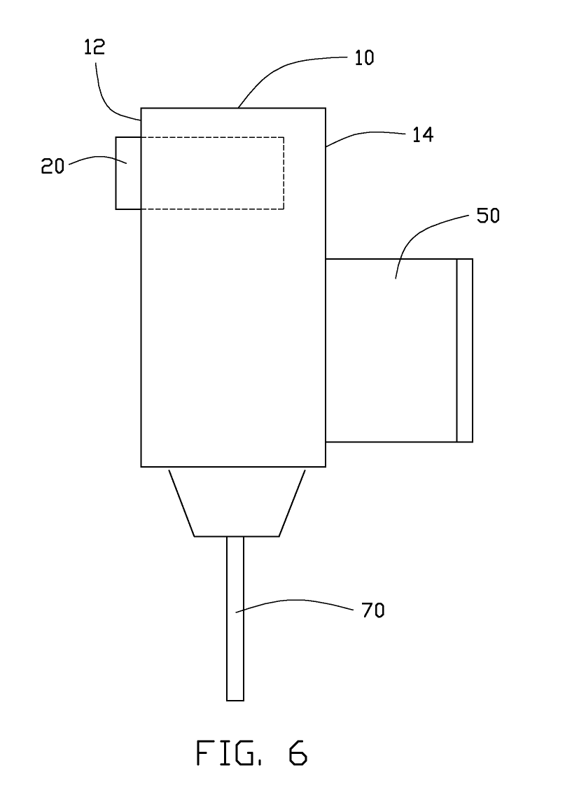

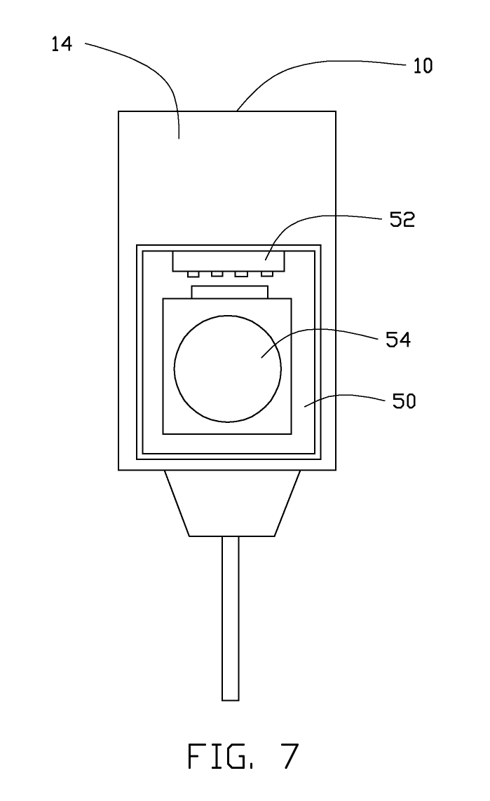

Referring to FIGS. 5 to 7, another embodiment of a power adapter connector is similar to the above embodiment, except that on the second side 14 of the main body 10, only a plug 50 is mounted thereto, which integrates a second USB interface 52 and a power interface 54. The plug 50 is not round, such as rectangular, to prevent the plug 50 from moving relative to the mini netbook. In other embodiments, the first and second USB interfaces may be replaced by other types of connectors, such as 1394 connectors.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A power adapter connector, comprising:
a main body comprising a first side and a second side;
a first interface mounted to the first side of the main body;
a second interface different from the first interface and mounted to the second side of the main body; and
a power interface mounted to the second side of the main body;
wherein the first interface is electrically connected to the second interface.

2. The power adapter connector of claim 1, wherein the first and second interfaces are both universal serial bus (USB) interfaces, and the second interface is a mini USB interface.

3. The power adapter connector of claim 1, wherein the second interface and the power interface are separately mounted to the second side of the main body.

4. The power adapter connector of claim 1, wherein the second interface and the power interface are integrated in a plug that is mounted to the second side of the main body.

5. The power adapter connector of claim 1, wherein the first side is opposite to the second side of the main body.
